(19) United States
(12) Patent Application Publication
(10) Pub. No.: US 2008/0262970 A1
(43) Pub. Date: Oct. 23, 2008

(54) System and method of electronic information delivery

(75) Inventors: Charles E. Engelke, Macon, GA (US); Craig L. Fitzgerald, Gainesville, FL (US); Ruben D. Orduz, Gainesville, FL (US)

Correspondence Address: ROGERS TOWERS, P.A., 1301 RIVERPLACE BOULEVARD, SUITE 1500, JACKSONVILLE, FL, 32207, US

(73) Assignee: Info Tech, Inc.

(21) Appl. No.: 12/148,357

(22) Filed: Apr. 18, 2008

Related U.S. Application Data
(60) Provisional application No. 60/925,360, filed on Apr. 20, 2007.

(51) Int. Cl. G06Q 30/00; H04L 9/00

(52) U.S. Cl. 705/64; 713/150; 713/168

(57) ABSTRACT

A system and method for web browser based, secure or authenticated electronic delivery of information, wherein the security or authentication is provided by a means of a public key cryptography encryption method. The system can be used as a web-based blind bidding method, wherein software is located and operated on a central server and within the end user's web browser. Thus, no software is installed onto the end user's computer. In addition, the bidding system uses two-way PKC encryption technology or symmetric encryption technology to sign and seal the bid data submitted by each bidder, said encryption technology being completely browser based.

This application claims the benefit of U.S. Provisional Patent Application Ser. No. 60/925,360, filed on Apr. 20, 2007.

### BACKGROUND AND SUMMARY OF THE INVENTION

The present invention generally relates to a web browser based sealed information delivery process, where the information exchange is authenticated and secured against viewing by the receiving party or any intermediary until a previously agreed upon time. One application of sealed information exchange is Internet sealed bidding.

Computer based communications has existed for several decades, as has web browser based communication. Under previous methods, sealed communication required the end user to install special software onto the user's computer. In the past, web browser based communication could not be sealed.

In the late 1990's, Internet sealed bidding became viable. At that time, Internet sealed bidding technology required the end user to download and install software onto the user's computer, compile the bid, and submit the bid electronically via the downloaded software. Potential bidders desired a method to perform Internet sealed bidding using only a web browser, without having to install special software. This was not possible, even though web browsers did provide a secure communications option, because that native method secured the data only in transit between the web browser and the web server, and could not seal the bid from viewing until an agreed upon deadline. As technology has improved in recent years, the Internet, and particularly the World Wide Web and web browsers, has gained the capability of supporting a browser-based sealed bidding process, wherein the end user does not need to install any software onto his or her computer.

The present invention enables this process by using a novel combination of publicly known web-based information technology, management applications, public key cryptographic technology, JavaScript tools, programming languages, programming interfaces, and servers. In the most basic embodiment of the invention, browser based information delivery can occur with varying levels of security and authenticity.

### BRIEF DESCRIPTION OF THE DRAWINGS

FIG. 1 is a flow chart of the web browser-based information delivery system.

FIG. 2 is a flow chart showing the web browser-based information delivery system delivering secured or authenticated input data.

FIG. 3 is a flow chart of the web browser-based bidding system.

FIG. 4 is a flow chart showing the interface between the web browser and the bidding information service.

FIG. 5 is a flow chart showing the steps of the browser-based bidding process.

### DETAILED DESCRIPTION OF THE INVENTION

With reference to the drawings, the invention will now be described with regard for the best mode and the preferred embodiment. In general, the invention is a system and method of web-based information transfer that is either authenticated or secure, or both. In particular the present invention allows the sender to input, alter, edit, seal, sign, and submit information inside the sender's web browser without installing software onto the sender's computer. The web-based information delivery system may be used in any situation where one or more parties uses the Internet to send information to a receiving party. The description below provides details for a generalized information transfer, exchange, or deliver, and the following parameters can be adopted for use under a wide variety of circumstances.

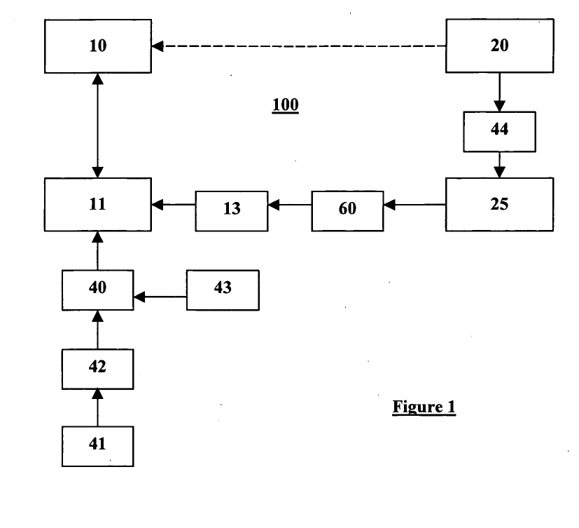

Referring to FIG. 1, the most basic embodiment of the invention is an information delivery process 50 carried out on a browser-based, information delivery system 100. The information delivery process 50 involves a receiving party, or provider 10, and a sending party, or sender 20. The provider 10 creates, operates, and supports the information delivery system 100, which is comprised of a server 11, web service 13, a management application 60, and a web page. Typically, the web service 13 comprises software that runs on the server 11. The web browser 25 communicates with the server 11 using a combination of appropriate web services 13, as described in more detail below. The server 11 should be secure so that the data stored thereon is protected from malicious third party intruders.

The parties could use the information delivery system for a variety of purposes, which can be designated by an information category 40. For example, the information category 40 could relate to, without limitation, payroll, scheduling, benefits, or project specific categories. The information delivery process 50 comprises the steps of establishing the delivery system 51, party registration 52, data delivery 53, and data reception 54. The step of establishing the delivery system 51 further comprises the steps of the provider 10 establishing a centralized server 51a and software 51b, said software running on the centralized server 51a.

In the step of party registration 52 the sender 20 registers with the provider 10 to use the electronic, browser-based information delivery system 100. In most applications, the registration may entail a one-time setup where the sender 20 is assigned a unique identification, such as a password, registration number, username, passphrase, or the like. The sender's 20 unique identification may be a combination of the aforementioned elements. For subsequent uses or information categories 40, the sender 20 may access the information delivery system 100 with the sender's 20 unique identification. After accessing the information delivery system 100, the sender 20 can establish any optional initial data 41, which could be any type of information, including, without limitation, proposals, payroll information, or project data. All such initial data 41 can be stored on the server 11 in a transaction file 42 unique to the sender 20. Such transaction files 42 are preferably encoded in the Extensible Markup Language (“XML”), which is a general purpose markup language that facilitates data sharing between different information systems. XML is particularly useful on the Internet. In addition, each information category 40 is typically given a unique category identification 43 so that each information category 40 may be distinguished from any others.

In the step of data delivery 53, a sender 20 can fetch from the server 11 a transaction file 42 for the information category 40. There may be several transaction files 42 for each information category 40. Any information stored in the transaction file 42, including any initial data 41, is then displayed in the sender's 20 web browser 25 for the sender 20 to review. The sender 20 may then enter input data 44 into the web browser 25. When the input data 44 is “saved,” the web browser 25 sends the input data 44 to the server 11 to be stored in the transaction file 42. Thus, during the step of data delivery 53, there is never any software installed on the sender's 20 computer, and the input data 44 need not be saved on the sender's 20 computer. All software remains either on the server 11 or running in the sender's 20 web browser 25, and all input data 44 and revised transaction files 42 are stored on the server 11. Finally, in the step of data reception 54, the provider 10 retrieves the transaction file 42 from the server 11 and reviews the data stored in the file.

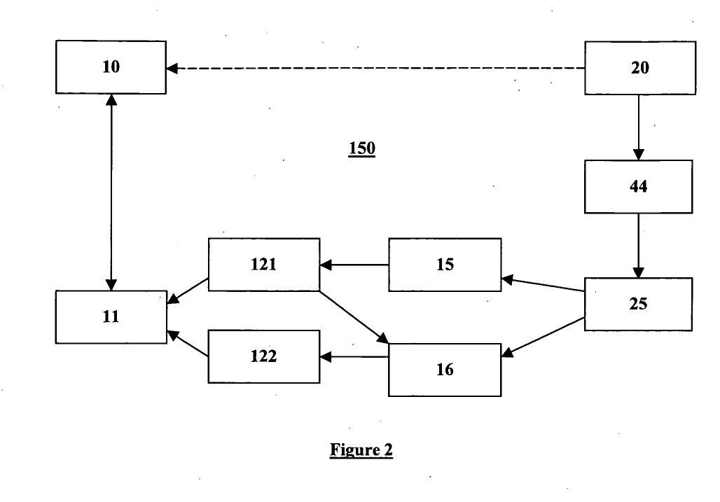

In one embodiment, shown in FIG. 2, the information delivery system 100 is used in connection with a secure submission system 150, which means that the sender 20 submits secured data 121 to the provider 10. Secured data 121 is information in electronic format that has been encrypted such that the information cannot be viewed by anyone other than the sender 20 or provider 10. The secure submission system 150 incorporates an encryption means 15 to secure the data transferred.

With an encryption means 15, the input data 44 is encrypted so that it remains protected during transmission and during storage on the server 11. The encryption means 15 can comprise any suitable symmetric or asymmetric key cryptography. Preferably, the encryption means 15 is public key cryptography (“PKC”), using any PKC standards. This technology uses asymmetric mathematical algorithms to “lock” the underlying data in a digital file. In another embodiment, the encryption means 15 uses symmetric cryptography, such as the Advanced Encryption Standard (“AES”) algorithm, which is a published American standard algorithm frequently used in symmetric key cryptography.

In PKC, users create and control keys in pairs, the first key being private (also called secret) and the second key being public. The provider 10 or sender 20 can create these keys during the step of party registration 52. The keys in a key pair are mathematically related to each other, but neither can be derived from the other. The user can encrypt data with one type of key, and the data may be decrypted only by using the other type of key. Anything encrypted with one type of key can be decrypted by the other. An important aspect of PKC is that the private key must be kept confidential. Preferably, the keys are not easily guessable or otherwise ascertainable.

In symmetric cryptography, either the provider 10 or sender 20 can create a single key, and then shares that key with the other party. The sharing mechanism must not disclose the key to any other party. Either party can encrypt data with the key, and either user can decrypt that encrypted data with the same key. Further, each party can be certain that any data encrypted with the key must have been produced by the other party or by themselves.

In use with PKC, the provider 10 and sender 10 each retain their own private keys and deliver to the other party their public keys. The provider 10 and sender 20 should each safeguard their own private data key The public key of provider 10 is the one used to create the encrypted data 121. Since only the provider 10 holds the corresponding private key; the provider 10 is the only entity that is able to decrypt the underlying encrypted data 121, deriving the original input data 44. Thus, the sender 20 can enter input data 44 into the web browser 25, where the input data 44 is encrypted using the provider's 10 public key before it is sent to the server 11. Then the provider 10 retrieves the encrypted input data 44 and decrypts it using the private key.

In use with symmetric cryptography, the sole shared key is the one used to create the encrypted data 121, and then either party can use the shared key to decrypt the encrypted data 121, deriving the original input data 44. Thus, the sender 20 can enter input data 44 into the web browser 25, where the input data 44 is encrypted using the shared key before it is sent to the server 11. Then the provider 10 retrieves the encrypted input data 44 and decrypts it using the shared key.

In a more refined embodiment using PKC, the encrypted input data 121 is further encrypted with the sender's 20 private key yielding encrypted and authenticated data 122 that is delivered to the provider 10. Provider 10 then decrypts the encrypted and authenticated data 122 using sender's 20 public key, yielding encrypted data 121 and thus also verifying that encrypted and authenticated data 122 was produced by sender 20 and not altered by any other party. Provider 10 then decrypts encrypted data 121 with provider's 10 private key, yielding original input data 44.

As an additional concern, PKC is relatively slow, and encrypting and decrypting large files with PKC is usually not practical. Thus, encrypted and authenticated data 122 is usually produced by encrypting a message digest of encrypted data 121 instead of the encrypted data itself and combining that encrypted message digest with encrypted data 121 to produce encrypted and authenticated data 122. For security reasons, replacing a file with another that has the same message digest must not be feasible. Also, the encrypted data 121 might not be created by directly encrypting input data 44 using the provider's 10 public key, due to the slow speed of such encryption on large files. Alternately, the sender may create a random “session key,” and use that session key to secure the input data 44 using faster symmetric cryptography, and then simply encrypt the session key with the provider's 10 public key. The encrypted session key is then combined with the symmetrically encrypted data to produce encrypted data 121. The provider 10 then uses the provider's 10 private key to decrypt the session key before using the session key to decrypt the underlying input data 44.

In one embodiment, the step of data delivery 53 is performed as follows. The sender 20 fetches a web page used to deliver to the provider 10 data for a particular information category 40a. This web page contains either no data or initial data 41. More importantly, this web page contains JavaScript code that runs when the web page loads. The JavaScript for the initial page load connects to a web service 13a, called “fetchcategory” for example, which requests retrieval from the server 11 of the transaction file 42 for the information category 40a. The web service 13a returns that transaction file 42, which the JavaScript keeps in an object that can be traversed and modified. The page load JavaScript then traverses the object and creates web page form elements for all the data to be entered as, for example, input data 44. As these elements are created, the web browser 25 automatically displays them. This step is usually so fast that it will appear instantaneous. The sender 20 then enters the input data 44 on the form displayed in the web browser 25. When finished, the sender 20 clicks a button to save this input data 44. This invokes another JavaScript function to save the input data 44 on the server 11.

The data-saving JavaScript first reads all the form elements to get the data entered by the sender 20 and adds those data elements to the object it already obtained from the transaction file 42. The object is then converted to a text string, which is then encrypted using a shared key entered by the sender 20 or a public key created by the provider 10 and included in the web page or transaction file, or separately fetched from the server, thus creating the secured data 121. The JavaScript then sends the secured data 121 to a web service 13b, called “savedata” for example, telling the web service 13b to save this secured data 121 in information category 40 for sender 20. The web service 13b saves the secured data 121 to the server 11 for the next time the sender 20 seeks to revise it. Note that the unencrypted input data 44 is never saved anywhere, and it exists only in the live web page created on-the-fly by the JavaScript in the web browser 25. All data is encrypted before it ever leaves the browser, and the server 11 holds the secured data 121 for the sender 20 to revise in the future or for the provider 10 to decrypt and read.

In another embodiment of the step of data delivery 53, the input data 44 can be authenticated, which can be done either with or without data encryption as previously described. An authentication means 16 is used to ensure that the purported identity of the sender 20 is genuine and that the submitted input data 44 has not been altered. Authentication can occur by several means with varying degrees of strength. For example, one authentication means 16 is simply the sender's 20 aforementioned unique identification, such as a user name, passphrase or the other identifiers listed above, or a combination thereof. This form of authentication means 16 provides a relatively weak level of authentication. By contrast, the authentication means 16 could be a digital signature, which is a much stronger form of authentication.

In one embodiment, the authentication means 16 is a digital signature using the sender's 20 key pair, which is created by the sender 20 during the step of party registration 52. The signature key pair, which is used to create a digital signature, can be the same as one used for encryption or a separate key pair, and comprises a private signature key and a public signature key. A digital signature uses special technology to provide more assurance that the signature is not forged and that the data file has not been altered after being signed. The sender 20 retains the private signature key. Access to this key will be proof of the identity of the sender 20. The private signature key can be backed up and used on several different computers. The sender 20 then registers the public signature key with the provider 10, along with an optional traditional signed legal agreement binding the parties to an agreed level of confidentiality and reliance with respect to the signature keys.

In use, the sender 20 enters the input data 44 into the web browser 25, where the input data 25 or the encrypted data 121 is digitally signed using the private signature key. Then the web browser 25 sends the signed data to the server 11. The provider 10 can then retrieve the signed data and verify the sender's digital signature using the public signature key. Since the sender 20 is the only party having access to the private signature key, the provider 10 has greater assurance that the sender 20 is the party that actually sent the signed data and that the signed data has not been altered.

This embodiment, using an authentication means 16, uses web services 13 in the same manner as that previously described for an embodiment incorporating an encryption means 15.

In the final step, data reception 54, the provider 10 uses the private data key or public signature key to either decrypt or verify the input data 44, as described above.

In another embodiment, the browser based electronic information delivery system can be used for electronic bidding, wherein the bidding system incorporates software applications that run in the bidder's web browser. In particular the present invention allows the bidder to input, alter, edit, sign, seal, and submit bid data without installing software onto the bidder's computer. This embodiment may be particularly useful for government agencies that solicit bids for public works projects. However, the electronic bidding system may be used in any situation where one or more parties solicit bids from a class of bidders, such as a private developer soliciting bids from contractors or a general contractor soliciting bids from subcontractors. The description below provides details for bidding on a project to be completed by the bidder. An ordinary practitioner will understand that with minimal effort, the bidding method described below could be adapted for bidding on an item to be purchased by the bidder.

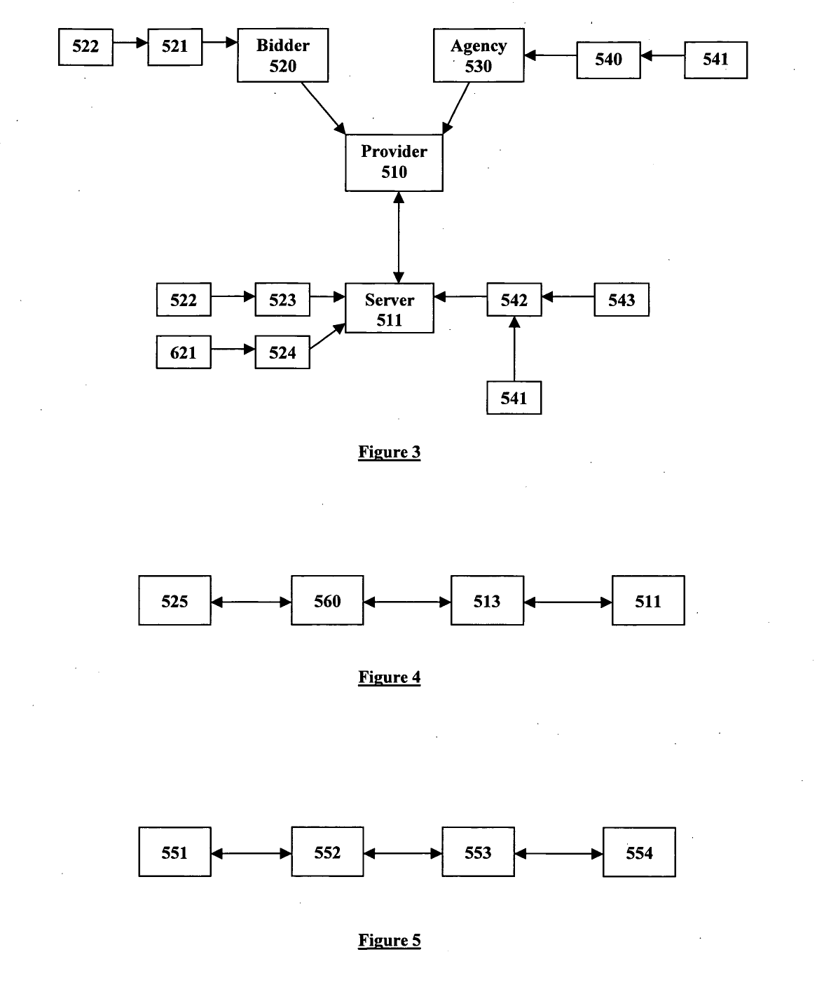

Referring to FIGS. 3-5, this embodiment comprises a bidding method 550 carried out on a bidding system 500. The bidding method 550 involves a provider 510, at least one bidder 520, at least one agency 530, and at least one project 540. The provider 510 creates, operates, and supports the bidding system 500 (see FIG. 3), which is comprised of a server 511 supporting a web page, web-based bidding information service 513, management application 560, and a web page. Typically, the bidding information service 513 comprises software that runs on the server 511, and some bidding information services 513 are available in commercial software packages. The server 511 should be secure so that the data stored thereon is protected from malicious third party intruders. As shown in FIG. 3, the management application 560 provides an interface between a web browser 525 and the bidding information service 13.

Generally, the bidder 520 is the entity that will perform the project 540 for the agency 530. The agency 530 is the owner of the project 540, and the agency 530 may be a private owner or a public owner, such as a government agency. The project 540 is the underlying work or service to be performed by the bidder 520. For example, the project 540 may be a public works project, a consulting project, or the like.

As shown in FIG. 5, the bidding method 550 comprises the steps of establishing the bidding system 551, agency registration 552, bid submission 553, and bid opening 554. The step of establishing the bidding system 551 further comprises the steps of establishing a centralized server 551a and loading the bidding software 551b to run on the server 511.

In the step of agency registration 552 the agency 530 registers with the provider 510 to use the electronic bidding system 500. In most applications, the registration may entail a one-time setup where the agency 530 is assigned a unique identification, such as a password, registration number, username, passphrase, or the like. The agency's 530 unique identification may be a combination of the aforementioned elements. On subsequent projects 540, the agency 530 may access the bidding system 500 with the agency's 530 unique identification. After accessing the bidding system 500, the agency 530 may input into a web browser 525 project data 541, including proposals, addendums, instructions, and any other information needed to define the scope, substance, duration of the project 540, or other information material to formulating a bid 521. All such project data 541 is then stored on the server 511 in a project file 542 unique to the project 540. The project file 542 is preferably encoded in XML as described above. In addition, the project 540 is typically given a unique project identification 543 so that each project 540 may be distinguished from another. In addition, the agency 530 may designate specific times for bidding to open and close, and such designations are included in the project data 41.

In the step of bid submission 553, the bidder 520 may register with the provider 510 to use the bidding system 500. Preferably, upon registration, the bidder 520 is assigned a unique identification, such as a password, registration number, username, passphrase, or the like. The bidder's 520 unique identification may be a combination of the aforementioned elements. After registration, a bidder 520 may fetch from the server 511 the project file 542 for the project 540. The project data 541 stored in the project file 542 is then displayed in the bidder's 520 web browser 525 for the bidder 520 to review. The bidder 520 may then input bid data 522 into his or her browser. When the bid data 522 is “saved,” the browser sends the bid data 522 to the server 511 to be stored in a bid file 523 unique to the particular bidder 520 and the particular bid 521. When the bidder 520 is finished inputting bid data 522, the bidder 520 has created the bid 521. Thus, during the step of bid submission 553, there is never any software downloaded onto the bidder's 520 computer, and the bid data 522 is not saved on the bidder's 520 computer. All software remains either on the server 511 or running in the bidder's 520 web browser 525, and all bid data 522 and resulting bids 521 are stored on the server 511 in the bid file 523.

The step of bid opening 554 begins after the time for bidding has closed. In this step, provider 510 sends all of the bids files 523 to the agency 530. The agency 530 then opens the bid files 523, reviews the bids 521 contained therein, and selects the winning bid 521.

Preferably, the bidding system 500 is used in connection with a blind bidding process 650, which means that bidders 520 submit sealed bids 621 and the agency 530 cannot view the sealed bids 621 until the predetermined time for bid letting occurs, as described in more detail below. A sealed bid 621 is a bid 521 that has been encrypted such that the bid 521 cannot be viewed by anyone other than the bidder 520 until the time for bidding closes. The blind bidding process 650 incorporates a security means 512 to protect the integrity of the blind bidding process 650. The security means 512 comprises a means of encryption and a means for authentication. The bid data 522 is encrypted so that it remains protected during transmission and during storage on the server 511. The means for authentication is used to ensure that the purported identity of the bidder 520 is genuine and that the submitted bid data 522 has not been altered.

The means of encryption may comprise any suitable symmetric or asymmetric key cryptography. Preferably, the means of encryption is PKC using any PKC standards, as described above.

Optionally, during the step of agency registration 552, the agency 530 may designate to the provider 510 the bidders 520 that the agency 530 will permit to submit sealed bids 621. The bidders 520 register with the provider 510, and each bidder 520 creates a key pair, which is the signature key pair. The signature key pair, which is used to create a digital signature, comprises a private signature key and a public signature key. A digital signature uses special technology to provide more assurance that the signature is not forged and that the data file has not been altered after being signed. The bidder 520 retains the private signature key. Access to this key will be proof of the identity of the bidder 520. The private signature key can be backed up and used on several different computers. The bidder 520 then registers the public signature key with the provider 510, along with an optional traditional signed legal agreement binding the parties to an agreed level of confidentiality with respect to the signature keys.

The agency 530 also creates a key pair, which is the bid key pair. The bid key pair comprises a private bid key and a public bid key. The agency 530 retains the private bid key with appropriate safeguards. The agency 530 then discloses the public bid key to the bidders 520. This may be accomplished either directly or by the agency 530 delivering the public bid key to the provider 510, who then discloses the public bid key to each bidder 520 when the bidder 520 registers to bid on the project 540. Since there is only one private bid key, which is held by the agency 530, the agency 530 is the only entity that is able to decrypt the sealed bid 621. As before, the agency 520 should safeguard the private bid key, disclosing it only to authorized staff.

After the bidder 520 finalizes the bid data 522 during the step of bid submission 553, the bidder 520 first encrypts the bid data 522 using the public bid key, thereby creating the sealed bid 621. Then the bidder 520 signs the sealed bid 621 using the private signature key. Finally, the bidder 520 submits the sealed bid 621 to the provider 510. The provider 510 uses the public signature key to verify that the sealed bid 621 was submitted by one having access to the bidder's 520 private signature key. In addition, the provider 510 uses the public signature key to verify that the sealed bid 621 remains unaltered after it was signed with the private signature key and that there were no errors in transmission of the sealed bid 621. The sealed bid 621 is then stored in an encrypted bid file 524 on the server 511 until the time for bidding closes and the provider 510 forwards all sealed bids 621 to the agency 530. Since the provider 510 does not have the private bid key, the provider 510 cannot decrypt a sealed bid 621 while it is being stored on the server 511. In addition, the agency 530 cannot access the sealed bid 621 prematurely because the agency 530 does not have access to the bidder's 520 secret passphrase shared with the provider 510 when the bidder 520 registers for the project 540.

The bid letting occurs when the provider 510 sends the sealed bids 621 to the agency 530. Optionally, the provider 510 may send the public signature keys to the agency at this time, thereby allowing the agency 530 to double-check the bidder's 520 identity and the integrity of the sealed bids 621. The agency 530 then uses the private bid keys to decrypt the sealed bids 621. The agency 530 reviews the decrypted bids and selects the winning bid.

The step of bid submission 553 is performed as follows. The bidder 520a fetches a web page to be used to bid a specific project 540a for a specific agency 530a. This web page does not contain any of that project data 541 yet, but it does contain JavaScript code that runs when the web page loads. The JavaScript for the initial page load connects to a web service 513a, called “fetchproject” for example, which requests retrieval from the server 511 of the project file 542 for the project 540a from the agency 530a. The web service 513a returns that project file 542, which the JavaScript keeps in an object that can be traversed and modified. The page load JavaScript then traverses the object and creates web page form elements for all the data to be entered for a bid 521a. As these elements are created, the web browser 525 automatically displays them. This step is so fast that it will appear instantaneous. The bidder 520a then fills in the bid prices on the form. When finished, the bidder 520a clicks a button to save this bid 521a. This invokes another JavaScript function to save the bid 521a on the server 511.

The bid-saving JavaScript first reads all the form elements to get the prices entered by the bidder 520a and adds those prices to the object it already obtained from the project file 542. The object is then converted to a text string, which is then encrypted using a key entered by the bidder 520a or provided by the provider 10 in the original web page or with the initial bid data or a by separate web service request, thus creating an sealed bid 621. The JavaScript then sends the sealed bid 621 to a web service 513b, called “savebid” for example, telling the web service 513b to save this sealed bid 621 for project 540a of agency 530a, for bidder 520a. The web service 513b saves the sealed bid 621 to the server 511 for the next time the bidder 520a seeks to revise it. These steps begin the bidding process. Note that the unencrypted bid 521a is never saved anywhere, and it exists only in the live web page created on-the-fly by the JavaScript in the browser. The bid 521a is encrypted before it ever leaves the browser, and the server 511 holds the sealed bid 621 for the bidder 520a to revise in the future.

When the bidder 520a is ready to submit the bid 521a, the process is substantially the same, except that a digital signature is applied to the sealed bid data before submission. However, the JavaScript displays a message to the effect that the bidder 520a intends to sign and submit the bid 521a, and then sends it to a different web service 513c, called “submitbid” for example. This web service 513c is similar to web service 513b, except that web service 513c puts the sealed bid 621 in a holding area on the server 511 for later download by the agency 530a. If the bidder 520a wants to revise an already saved sealed bid 621b, the start of the above process is modified slightly. Instead of starting by fetching the XML for an empty bid 521a, the JavaScript will use a different web service 513d, called “fetchbid” instead of “fetchproject” for example, to download the saved sealed bid 621b. It will have to decrypt the sealed bid 621b using the bidder's 520a passphrase to access the XML that starts the revision process.

As a result of these processes, the bidding system 500 needs one generic web page that can be used to bid any project 540a, JavaScript to talk to web services 513a-513d and update and read the web page, and four web services 513a-513d: fetchproject, savebid, submitbid, and fetchbid, respectively. Preferably, the bidding system 500 includes a fifth web service 513e, called “withdrawbid” for example, that allows a bidder 520a to remove a previously submitted bid 621a.

The management application 560 advertises projects 540 for bid and their project data 541, and receives the bids 521 after the bid opening deadline. Several such management applications 560 are commercially available, such as Appia. The management application 560 must communicate with the server 511, which in turn must provide web services to enable such communication. In particular, there are four fundamental services needed from the server 511: a first service for the management application 560 to use to post projects 540 and project data 541, a second service to determine the identity of the bidder 520 who has submitted bids 521, a third service to receive bids 521, and a fourth service for the agency 530 to authorize bidders 520.

For example, “advertiseproject” may be a service used to tell the bidding information service 513 about a new project 540 or project data 541. Advertiseproject needs the agency's 530 unique identification, the project identification 543, and the project file 542. Advertiseproject returns an output of “success” or “failure” status. The bidding information service 513 will parse the XML project file 542 to get any project data 541 it needs to manage the service. The “listbids” service returns a list of the unique identifications for each bidder 520 that has submitted a sealed bid 621 for a particular project 540. Listbids requires the agency's 530 unique identification and the project identification 543. Listbids an output of “success” or “failure” status, and it always returns a failure status until the bid opening deadline has passed. The “openbid” service request a specific sealed bid 621, which the management application 560 will then decrypt and process. Openbid requires the agency's 530 unique identification, the project identification 543, and the bidder's 520 unique identification. Openbid returns an output of “success” or “failure” status, and it always returns a failure status until the bid closing deadline has passed. If successful, openbid returns the sealed bid 621 for the specified project 540 and bidder 520.

All of these web services need to authenticate the agency 530, such as by a username and pass phrase, or credentials distributed by the provider as a licensing file. For example, credentials may be created by using the elements in the agency's 530 management application 560 licensing file. As a result, the provider 510 is able to verify that the credentials are authentic by checking the originally distributed credentials from the licensing file.

Finally, if the agency 530 chooses to accept bids from only selected bidders, then each time an agency 530 authorizes a bidder 520 to bid via the Internet, the agency 530 must enter the bidder identification into the management application 560. The management application 560 then sends the bidder identification to the bidding information service 513, so that it can verify bidder's 520 bid 521 submissions. Thus, the “authorizebidder” service tells the bidding information service 513 that a particular bidder 520 is authorized to use it for bidding with the agency 530. Authorizebidder returns an output of “success” or “failure” status.

Included in the project data 541 is a value that increases every time the agency 530 creates a new version of the XML project file 542. Preferably, the value is a sequential number, or it could be an ISO-format timestamp, such as (2006-11-07T14:01Z) or the like. The provider's 510 client-side software can use this information to verify that the project file 542 accessed by the user is the most current version. For example, the bidding JavaScript in the bidder's 520 browser may fetch a saved sealed bid 621, then fetch a current project 540, and compare their version numbers. The server 511 may also monitor the version numbers so the provider 510 can actively notify the bidder 520 of revised project data 541, or refuse to accept a bid 521 that is not at the current version. To achieve this result, the web services 513 may use an additional parameter to the “savebid” web service 513b and the “submitbid” web service 513c, the additional parameter being “version.” That value will match the value in the XML project file 542 as of the time the bid 521 is saved or submitted by the bidder 520.

To support the browser based bidding system 500, the bidding server 511 must implement several application programming interfaces (“API”). An API is a source code interface provided by a computer system for the purpose of supporting service requests made by computer software. APIs are a type of web service, and the APIs needed in the present invention fall into two broad classes: APIs used by the web application the bidder 520 is using (bidder API), and APIs used by the web application that the agency 530 is using (agency API). The agency's 530 APIs are typically invoked by a computerized preconstruction management system, several of which are common in the art. In using the APIs, the computer software must make Hypertext Transfer Protocol (“HTTP”) requests to the proper URL location, send the correct information with the requests, and understand the API's response to the requests.

The bidding system 500 uses an interface protocol to transfer information between the server 511 the web browsers 525 used by the bidder 520 and the agency 530. Often, the interface protocol is the Common Gateway Interface (“CGI”) protocol, and information is transferred using normal CGI parameter-passing conventions. However, other protocols also are suitable to perform this function.

The user (thus, either the bidder 520 or the agency 530) sends information to the APIs. The response returned to the user is either a HTTP response code indicating some form of an unexpected error, or an “HTTP 200 OK” response code with additional content, thus indicating that the transmission was acceptable. Preferably, the response content may be of MIME type text/xml, and will contain status information on the request as well as information appropriate to the request. MIME is an Internet Standard called Multipurpose Internet Mail Extension, and the MIME header indicates the type of content being transferred. Thus, “MIME type text/xml” indicates a text file in XML format being transferred in MIME.

Since there may be hardware, communication, or other unexpected errors, users should be able to address HTTP error codes. In one embodiment of the invention, that content will be an XML file, with a XML root element response or compliant with a declared Document Type Definition (“DTD”). DTD is an XML schema language used to conform certain declarations to a specified syntax and that describes the type of XML document as a function of the restrictions on the document's structure. The DTD explains the full details of the allowable XML format, said details being known to persons having ordinary skill in the art. There is always a result code meaning success or failure. In some instances, the response contains nothing more than the result code. In other instances, the response includes a data element containing the requested information.

In one embodiment of the invention, the web-based bidding information service 513 is Bid Express and the management application 560 is Appia, both of which are commercially available. In this embodiment, the bidder 520 APIs are as follows:

fetcbproject
Provides an XML project file 542 to the requester.
Parameters: agency 530 and projectid.
Response data: the XML project file 542.
   fetchbid
Provides an encrypted XML project bid file 524 to the requester (who must be the bidder 520).
Parameters: agency 530, projectid, contractorid, contractorcredentials.
Response data: the encrypted project XML bid file.
   savebid
Saves an encrypted bid (i.e. the sealed bid 621) for future editing. The saved bid will only ever be provided to the individual who saved it.
Parameters: agency 530, projectid, contractorid, contractorcredentials, bid 521.
Response: response status code. Possibly data as well, consisting of some kind of receipt for the saved data.
   submitbid
Saves an encrypted bid that's been electronically signed and submitted. The submitted bid (i.e. the sealed bid 621) will only ever be provided to the individual who saved it until the bid closing deadline, at which time it will be available to the agency 530 as well.
Parameters: agency 530, projectid, contractorid, contractorcredentials, bid 521.
Response: response status code and possibly data, which may consist of some kind of receipt for the submitted sealed bid 621.
   withdrawbid
Changes the status of a specific previously submitted sealed bid 621 to just “saved”.
Parameters: agency 530, projectid, contractorid, contractorcredentials, sealed bid 621.
Response: response status code and possibly data, which may consist of some kind of acknowledgment of the withdrawn sealed bid 621.
   The agency 530 APIs for this embodiment are as follows:
   advertiseproject
Receives an XML project file 542 from an agency 530 to make available to prospective bidders 520.
Parameters: project 540, agency 530, agencycredentials.
Response: a response code, and perhaps additional descriptive text (e.g., “new project advertised,” or “advertised project updated”).
   listbids
Return a list of contractorids that have submitted sealed bids 621 on a project 540.
Parameters: projectid, agency 530, agencycredentials.
Response: if the bid opening deadline has not yet passed, just an error code, and possibly data consisting of a text message explaining the problem. After the bid opening deadline passes, the return is a success response code and a list of contractorids that have submitted sealed bids 621. The DTD may be used to explain the syntax of the list.
   openbid
Returns a single encrypted bid (i.e. the sealed bid 621).
Parameters: projectid, agency 530, agencycredentials, contractorid.
Response: just an error code if there is no such sealed bid 621, or if the bid closing deadline has not yet passed. Otherwise, the return is a success code and the encrypted XML project bid file 524.
   authorizecontractor
Tells Bid Express that a specific bidder 520 can bid on the agency's 530 project 540.
Parameters: agency 530, contractorid, agencycredentials, contractorid.
Response: a status code indicating success or failure, and perhaps additional descriptive text (e.g., added new bidder 520, updated existing bidder 520).

Most of the API services need to authenticate an agency 530 or a bidder 520, and many of the API services work with projects 540, so the API services use many of the same parameters. For consistency and simplicity, those parameters have the same name and meaning regardless of the API function using them. The following is a complete list of parameters for the API for this embodiment of the present invention:

agency
The Appia agency name from the Appia configuration or license file.
   contractorid
The contractorid from that agency's 530 Appia “contractor” or “bidder” table.
   projectid
The Appia projectid for the project 540 being bid on.
   project
The XML project file 542 created by Appia.
   bid
An encrypted XML bid file 524 created by the bidding client and input by the bidder 520.
   contractorcredentials
A string proving the bidder 520 is an agent of the bidding entity.
   agencycredentials
A string providing evidence that the API user is actually the claimed agency 530. This will usually be a string created from information in the license file.

The embodiments disclosed above are merely representative of the invention and are not meant for limitation thereof. For example, an ordinary practitioner would understand that there are several commercially available substitutions or software packages for some of the features and components described above. Several embodiments described above incorporate steps or elements that are interchangeable with the features of other embodiments. It is understood that equivalents and substitutions for certain elements and components set forth above may be obvious to those having ordinary skill in the art, and therefore the true scope and definition of the invention is to be as set forth in the following claims.

We claim:

1. A secure submission system comprising:
a web page supported by a server, the web page capable of being fetched by a web browser running on a remote computer, wherein the web browser is capable of receiving input data;
one or more web services enabling communication between the server and the web browser, said one or more web services running on and being supported by the server and not the remote computer;
a management application functioning as an interface between the one or more web services and the web browser, said management application running on and being supported by the server and not the remote computer; and
an encryption means supported by the one or more web services and running in the web browser and not on the remote computer, said encryption means encrypting the input data.

2. The secure submission system of claim 1, wherein the encryption means comprises a public key cryptography encryption method or a shared key symmetric cryptography encryption method.

3. The secure submission system of claim 1, additionally comprising an authentication means supported by the one or more web services and running in the web browser and not on the remote computer.

4. The secure submission system of claim 3, wherein the authentication means incorporates a public key cryptography encryption method or a shared symmetric key encryption method, or shared credentials such as a username and password.

5. The secure submission system of claim 2, additionally comprising an authentication means supported by the one or more web services and running in the web browser and not on the remote computer.

6. The secure submission system of claim 5, wherein the authentication means incorporates a public key cryptography encryption method or a shared symmetric key encryption method, or shared credentials such as a username and password.

7. A secure submission system comprising:
a web page supported by a server, the web page capable of being fetched by a web browser running on a remote computer, wherein the web browser is capable of receiving input data;
one or more web services enabling communication between the server and the web browser, said one or more web services running on and being supported by the server and not the remote computer;
a management application functioning as an interface between the one or more web services and the web browser, said management application running on and being supported by the server and not the remote computer; and
an authentication means supported by the one or more web services and running in the web browser and not on the remote computer, said authentication means authenticating the input data.

8. The secure submission system of claim 7, wherein the authentication means incorporates a public key cryptography encryption method or a shared key symmetric encryption method.

9. A web browser based bidding system comprising:
a web page supported by a server, the web page capable of being fetched by one or more web browsers running on one or more remote computers, wherein each web browser is capable of receiving either bid data or project data;
one or more web services enabling communication between the server and the web browsers, said one or more web services running on and being supported by the server and not the remote computers;
a management application functioning as an interface between the one or more web services and the web browsers, said management application running on and being supported by the server and not the remote computers; and
a security means supported by the one or more web services and running in the web browsers and not on the remote computers, said security means comprising a means for encryption for securing the bid data and a means for authentication for authenticating the bid data.

10. The bidding system of claim 9, wherein the one or more web services further comprises one set of bidder APIs and one set of agency APIs.

11. The bidding system of claim 10, wherein the security means incorporates a public key cryptography encryption method or a shared key symmetric encryption method.

12. The bidding system of claim 10, wherein the management application further comprises a licensing file, wherein said licensing file permits authentication by the agency APIs.

13. A web browser based bidding method comprising the steps of:
establishing the bidding system, which further comprises the steps of establishing a centralized server and loading the bidding software that runs on the server;
agency registration, which further comprises the steps of establishing the agency's unique identification, inputting project data into a project file on the centralized server, and designating specific times for bidding to open and close;
bid submission, which further comprises the steps of registering the bidder by establishing the bidder's unique identification, using a web browser to retrieve the project data from the project file, entering bid data into the web browser, forming a sealed bid by using a security means inside the web browser to secure the bid data until a predetermined time for bid opening occurs, and delivering the sealed bid to the centralized server for storage; and
bid opening, which further comprises the steps of decrypting the sealed bid and reading the bid data.

14. The web browser based bidding method of claim 13, wherein the step of forming a sealed bid further comprises the step of using a public key cryptography encryption method or a shared key symmetric encryption method as a means of encryption and a means of authentication.
